(19) United States
(12) Patent Application Publication
(10) Pub. No.: US 2024/0347699 A1
(43) Pub. Date: Oct. 17, 2024

(54) NEGATIVE ELECTRODE ACTIVE MATERIAL FOR SECONDARY BATTERY, NEGATIVE ELECTRODE FOR SECONDARY BATTERY, AND SECONDARY BATTERY

(71) Applicant: MURATA MANUFACTURING CO., LTD., Kyoto (JP)

(72) Inventors: Yuichi SANO, Kyoto (JP); Yasuhiro IKEDA, Kyoto (JP); Qin SI, Kyoto (JP); Daisuke ITO, Kyoto (JP); Yuta KIGUCHI, Kyoto (JP)

(21) Appl. No.: 18/755,064

(22) Filed: Jun. 26, 2024

Related U.S. Application Data
(63) Continuation of application No. PCT/JP2023/005449, filed on Feb. 16, 2023.

(30) Foreign Application Priority Data
Mar. 22, 2022 (JP) 2022-045200

(51) Int. Cl. H01M 4/36; H01M 4/02; H01M 4/38; H01M 4/485

(52) U.S. Cl. CPC H01M 4/364; H01M 4/386; H01M 4/485; H01M 2004/027

(57) ABSTRACT

A negative electrode active material for a secondary battery includes a negative electrode active material particle that includes a first object including a silicon oxide, and a second object including at least one of copper, a copper compound, tungsten, or a molybdenum oxide and attached to a surface of the first object. A Raman spectrum of the negative electrode active material particle has a maximum peak within a range of greater than or equal to 470 cm⁻¹ and less than or equal to 490 cm⁻¹. An XRD spectrum thereof has a peak within a range of 37°±1° and a peak within a range of 44°±1°, has a peak within a range of 40°±1°, or has a peak within any one of a range of 23°±1°, a range of 25°±1°, a range of 37°±1°, a range of 41°±1°, a range of 54°±1°, or a range of 60°±10.

### CROSS REFERENCE TO RELATED APPLICATIONS

The present application is a continuation of PCT patent application no. PCT/JP2023/005449, filed on Feb. 16, 2023, which claims priority to Japanese patent application no. 2022-045200, filed on Mar. 22, 2022, the entire contents of which are incorporated herein by reference.

### BACKGROUND

The present technology relates to a negative electrode active material for a secondary battery, a negative electrode for a secondary battery, and a secondary battery.

A secondary battery has been widely used as a power source of any of various kinds of electronic equipment including, for example, mobile phones. The secondary battery is desired to be smaller in size and lighter in weight and allow for a higher energy density. The secondary battery includes a positive electrode, a negative electrode, and an electrolyte. The negative electrode includes a negative electrode active material that is to be involved in charging and discharging reactions.

The negative electrode active material has been considered in various ways. Specifically, for example, a negative electrode active material has been proposed that includes a particle including Si or SiO covered with porous MoO₂. Further, for example, a negative electrode active material has also been proposed that includes a particle including Si or SiO covered with Cu (copper).

### SUMMARY

The present technology relates to a negative electrode active material for a secondary battery, a negative electrode for a secondary battery, and a secondary battery.

Although consideration has been given in various ways regarding a battery characteristic of a secondary battery, there is room for further improvement in terms thereof.

It is therefore desirable to provide a negative electrode active material for a secondary battery, a negative electrode for a secondary battery, and a secondary battery that each make it possible to achieve superior battery performance.

A negative electrode active material for a secondary battery according to an embodiment of The present disclosure includes a negative electrode active material particle including a first object and a second object. The first object includes a silicon oxide. The second object includes at least one of copper, a copper compound, tungsten, or a molybdenum oxide and is attached to a surface of the first object. A Raman spectrum of the negative electrode active material particle detected by Raman spectroscopy has a maximum peak within a range of greater than or equal to 470 cm⁻¹ and less than or equal to 490 cm⁻¹. An XRD spectrum of the negative electrode active material particle detected by X-ray diffractometry (XRD) has a peak within a range of 37°±1 and a peak within a range of 44°±1, has a peak within a range of 40°±1, or has a peak within any one of a range of 23°±1, a range of 25°±1, a range of 37°±1, a range of 41°±1, a range of 54°±10, or a range of 60°±1°. An intensity of at least one of a peak within a range of greater than or equal to 227 eV and less than or equal to 240 eV or a peak within a range of greater than or equal to 930 eV and less than or equal to 938 eV in a photoelectron spectrum of the negative electrode active material particle detected by X-ray photoelectron spectroscopy (XPS) is less than or equal to 25% of an intensity of a peak within a range of greater than or equal to 98 eV and less than or equal to 104 eV in a photoelectron spectrum of the first object alone detected by X-ray photoelectron spectroscopy.

A negative electrode for a secondary battery according to an embodiment of the present disclosure and a secondary battery according to an embodiment of the present disclosure each include the negative electrode active material for a secondary battery according to the embodiment of the present disclosure described herein.

According to the negative electrode active material for a secondary battery, the negative electrode for a secondary battery, or the secondary battery according to an embodiment of the present disclosure, the negative electrode active material particle is included that includes the first object including the silicon oxide, and the second object including at least one of copper, the copper compound, tungsten, or the molybdenum oxide and attached to the surface of the first object. The negative electrode active material particle has a predetermined profile. Accordingly, a battery reactant easily reaches the first object, and insertion and extraction of the battery reactant are smoothly performed. Accordingly, the negative electrode active material for a secondary battery, the negative electrode for a secondary battery, and the secondary battery are each suitable to achieve superior battery performance.

Note that effects of the present disclosure are not necessarily limited to those described above and may include any of a series of effects described below in relation to the present technology.

### BRIEF DESCRIPTION OF THE FIGURES

FIG. 1 is a diagram schematically illustrating a configuration of a negative electrode active material for a secondary battery according to an embodiment of the present disclosure.

FIG. 2 is a perspective view of a configuration of a secondary battery (including a negative electrode for a secondary battery) according to an embodiment of the present technology.

FIG. 3 is a sectional view of a configuration of a battery device illustrated in FIG. 2.

FIG. 4 is a block diagram illustrating a configuration of an application example of the secondary battery.

FIG. 5 is a sectional view of a configuration of a secondary battery for testing.

### DETAILED DESCRIPTION

The present disclosure is described below in further detail including with reference to the drawings according to an embodiment.

A description is given first of a negative electrode active material for a secondary battery according to an embodiment of the present technology.

The negative electrode active material for a secondary battery (hereinafter simply referred to as a “negative electrode active material”) described herein is a material into which an electrode reactant is to be inserted and from which the electrode reactant is to be extracted. The negative electrode active material is used for a negative electrode, of a secondary battery, which causes an electrode reaction to proceed.

The electrode reactant is not particularly limited in kind, and specific examples thereof include a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. That is, the negative electrode active material is a material into which lithium is to be inserted as the electrode reactant and from which lithium is to be extracted as the electrode reactant. In the negative electrode active material, lithium is inserted and extracted in an ionic state.

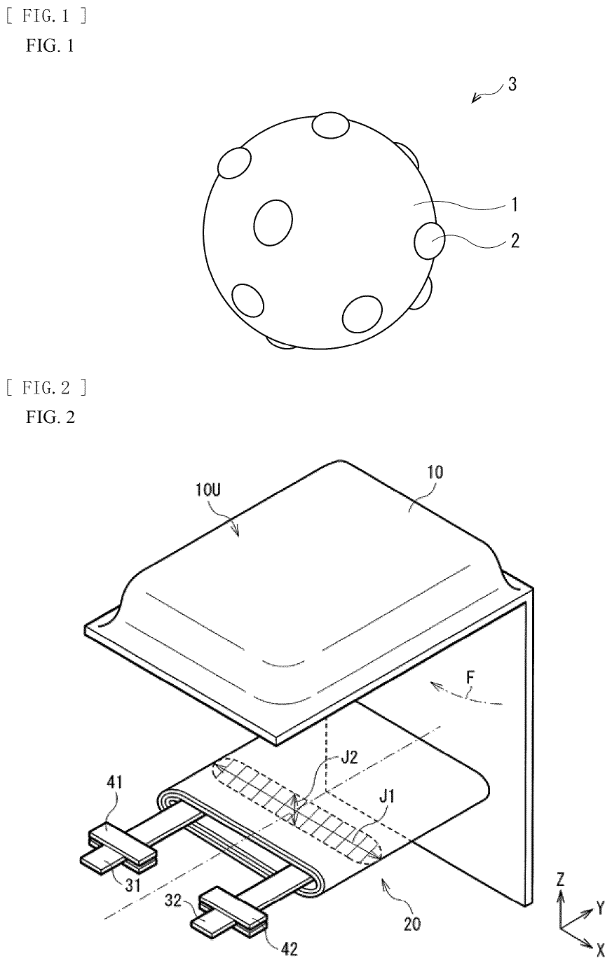

The negative electrode active material for a secondary battery includes, for example, negative electrode active material particles 3. The negative electrode active material particles 3 each include a first object 1 and a second object 2, for example, as illustrated in FIG. 1. Note that FIG. 1 is an explanatory diagram schematically illustrating one negative electrode active material particle 3.

The first object 1 is, for example, a particulate object including a silicon oxide such as SiO or SiO₂ as a main constituent element. An average particle size of the first object 1 is not particularly limited, and is, for example, greater than or equal to 1 μm and less than or equal to 10 μm, and preferably greater than or equal to 2 μm and less than or equal to 6 μm. It is desirable that the first object 1 have an amorphous structure.

The first object 1 may further include, as one or more negative electrode materials into which the electrode reactant is insertable and from which the electrode reactant is extractable, any one or more of materials including silicon as a constituent element, in addition to the silicon oxide. Hereinafter, the material including silicon as a constituent element is referred to as a “silicon-based material”.

The silicon-based material is not particularly limited in kind as long as the silicon-based material includes silicon as a constituent element. That is, the silicon-based material may be a simple substance of silicon, an alloy of silicon, or a compound of silicon. The silicon-based material may include two or more of the simple substance of silicon, the alloy of silicon, and the compound of silicon, or may be a material including one or more phases thereof in at least a portion thereof. Note that the “simple substance” merely refers to a simple substance in a general sense (in which a small amount of impurity may be included), and does not necessarily refer to a simple substance having a purity of 100%.

The alloy of silicon may include one or more metal elements as one or more constituent elements together with silicon, or may include one or more metal elements and one or more metalloid elements as constituent elements together with silicon. Additionally, the alloy of silicon may further include one or more non-metallic elements as one or more constituent elements.

Specifically, the alloy of silicon includes, as one or more constituent elements other than silicon, for example, any one or more of boron, tin, nickel, copper, iron, cobalt, manganese, zinc, indium, gold, silver, titanium, germanium, bismuth, antimony, or chromium.

Specific examples of the alloy of silicon and the compound of silicon include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, Si₃N₄, Si₂N₂O, and LiSiO.

The second object 2 includes, as a main constituent element, for example, at least one of copper, a copper compound, tungsten, or a molybdenum oxide, and is attached to a surface of the first object 1. The second object 2 is attached to the surface of the first object 1 in an island shape or in a spot shape to selectively cover the surface of the first object 1. Alternatively, a plurality of the second objects 2 is scattered to selectively cover the surface of the first object 1. Note that some of the second objects 2 may be connected with each other. Further, the second objects 2 may be different in size from each other. Further, FIG. 1 schematically illustrates the second object 2 having an outer shape that forms a portion of an ellipsoid or a portion of a sphere. However, the shape of the second object of the present disclosure is not limited thereto, and may be any other shape such as a shape having a recessed and protruding portion in a portion thereof. In any case, the surface of the first object 1 is not entirely covered with the second object 2, and a portion of the surface of the first object 1 is exposed.

The copper compound included in the second object 2 includes, for example, at least one of CuO, Cu₂O, CuCO₃, or Cu(OH)₂. Further, the molybdenum oxide included in the second object 2 includes, for example, MoO₂, MoO₃, or both. It is desirable that the second object 2 have an amorphous structure. The second object 2 is not particularly limited in thickness, and has, for example, a thickness of less than or equal to 1 nm.

A Raman spectrum of the negative electrode active material particle 3 detected by Raman spectroscopy is extremely similar to a Raman spectrum of the first object 1 alone detected by Raman spectroscopy. The negative electrode active material particle 3 has a maximum peak within a range of greater than or equal to 470 cm⁻¹ and less than or equal to 490 cm⁻¹ in the Raman spectrum detected by Raman spectroscopy. This means that amorphous silicon is present on a surface layer of the negative electrode active material particle 3. That is, this means that a portion of the surface of the first object 1 is not covered with the second object 2 and is exposed. Note that an excitation wavelength when detecting the Raman spectrum described above is set to, for example, 532 nm.

The negative electrode active material particle 3 has a peak within a range of 37°±1 and a peak within a range of 44°±1, has a peak within a range of 40°±1, or has a peak within any one of a range of 23°±1, a range of 25°±1, a range of 37°±1, a range of 41°±1, a range of 54°±10, or a range of 60°±1 in an XRD spectrum detected by X-ray diffractometry (XRD). Note that when detecting the XRD spectrum described above, the XRD spectrum is measured with, for example, Cu-Kα radiation of 0.154 nm at an acceleration voltage of 40 kV.

Further, an intensity of at least one of a peak within a range of greater than or equal to 227 eV and less than or equal to 240 eV or a peak within a range of greater than or equal to 930 eV and less than or equal to 938 eV in a photoelectron spectrum of the negative electrode active material particle 3 detected by X-ray photoelectron spectroscopy (XPS) is less than or equal to 25% of an intensity of a peak within a range of greater than or equal to 98 eV and less than or equal to 104 eV in a photoelectron spectrum of the first object 1 alone detected by X-ray photoelectron spectroscopy. Note that the peak observed within the range of greater than or equal to 227 eV and less than or equal to 240 eV corresponds to a molybdenum oxide. The peak observed within the range of greater than or equal to 930 eV and less than or equal to 938 eV corresponds to copper and a copper compound. Further, when detecting the photoelectron spectrum described above, the photoelectron spectrum is measured with, for example, Mg-Kα radiation of 0.989 nm at an acceleration voltage of 10 kV. Further, the photoelectron spectrum of the negative electrode active material particle 3 a surface of which has been etched to a depth of 200 nm at an etching rate of less than or equal to 3 nm/sec with an Ar ion accelerated by an acceleration voltage of 1 kV.

A composition ratio of Cu (copper) to Si (silicon) in the negative electrode active material particle 3 determined from the photoelectron spectrum of the negative electrode active material particle 3 detected by X-ray photoelectron spectroscopy is greater than or equal to 1% and less than or equal to 3%.

A coverage of the second object is greater than or equal to 1% and less than or equal to 3% of the first object in the negative electrode active material particle 3. The coverage is determined from the photoelectron spectrum of the negative electrode active material particle 3 detected by X-ray photoelectron spectroscopy.

The negative electrode active material particle 3 is formed by means of, for example, a barrel sputtering apparatus. Specifically, the first object 1 in the form of powder is put into a polygonal barrel placed inside a chamber. A temperature inside the polygonal barrel is set to a predetermined temperature (for example, 30° C.). A target including a raw material of the second object 2 is placed inside the chamber. A vacuum is drawn inside the chamber in this state by a pump, and while supplying a predetermined gas (for example, an Ar gas), the polygonal barrel is rotated at a predetermined rotational velocity (for example, 100 rpm) to repeat forward rotation and reverse rotation within a predetermined rotational angular range (for example, ±60°). At this time, the target is heated (for example, the target is heated to a temperature of greater than or equal to 30° C. and less than or equal to 100° C.) to thereby selectively attach the second object 2 to the surface of the first object 1 inside the polygonal barrel. Thereafter, heat treatment is performed on an as-needed basis, thereby making it possible to obtain the negative electrode active material particle 3.

According to the negative electrode active material for a secondary battery of the present disclosure, the negative electrode active material particle 3 is included that includes the first object 1 including the silicon oxide, and the second object 2 attached to the surface of the first object 1 and including at least one of copper, the copper compound, tungsten, or the molybdenum oxide. The negative electrode active material particle 3 has a predetermined profile. Accordingly, when the negative electrode active material for a secondary battery is applied to a secondary battery, a battery reactant easily reaches the first object 1, and insertion and extraction of the battery reactant are smoothly performed. The negative electrode active material for a secondary battery is therefore suitable to achieve superior battery performance.

More specifically, according to the negative electrode active material for a secondary battery of the present disclosure, it is possible to enhance an initial charge capacity and an initial discharge capacity, as compared with a negative electrode active material in which the second object 2 is not attached to the first object 1, or as compared with a negative electrode active material in which the second object 2 uniformly covers the surface of first object 1.

A description is given next of a secondary battery according to an embodiment of the present disclosure. A negative electrode for a secondary battery (hereinafter simply referred to as a “negative electrode”) according to an embodiment of the present disclosure is a portion or a component of the secondary battery, and is thus described below together with the secondary battery.

The secondary battery to be described herein is a secondary battery in which a battery capacity is obtained through insertion and extraction of an electrode reactant, and includes a positive electrode, a negative electrode, and an electrolytic solution. The electrolytic solution is a liquid electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Examples are given below of a case where the electrode reactant is lithium. A secondary battery in which a battery capacity is obtained through insertion and extraction of lithium is what is called a lithium-ion secondary battery.

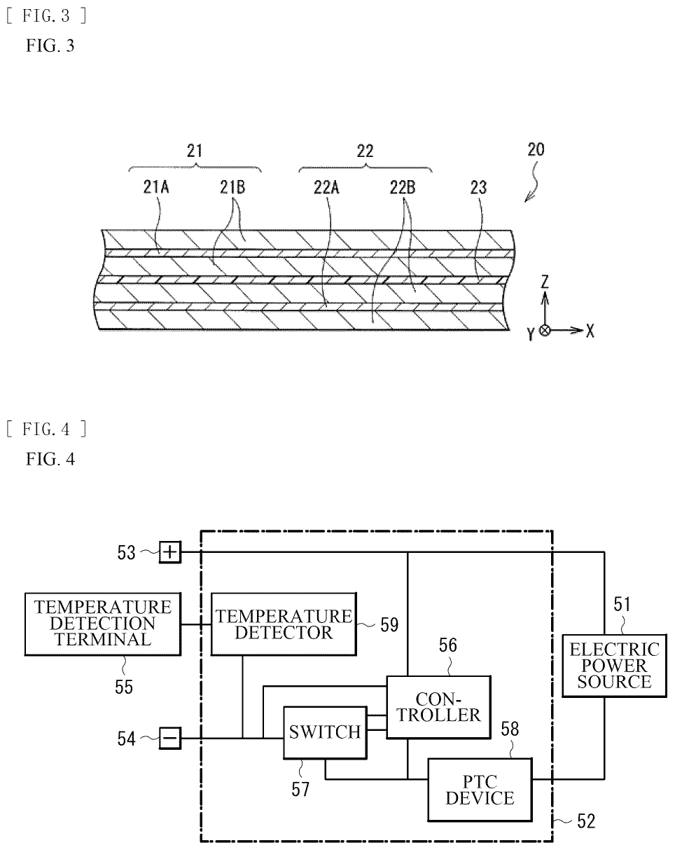

FIG. 2 illustrates a perspective configuration of the secondary battery. FIG. 3 illustrates a sectional configuration of a battery device 20 illustrated in FIG. 2. Note that FIG. 2 illustrates a state in which an outer package film 10 and the battery device 20 are separated from each other. FIG. 3 illustrates only a portion of the battery device 20.

As illustrated in FIG. 2, the secondary battery includes the outer package film 10, the battery device 20, a positive electrode lead 31, a negative electrode lead 32, and sealing films 41 and 42. The secondary battery described here is a secondary battery of a laminated-film type in which the outer package film 10 having flexibility or softness is used as an outer package member to contain the battery device 20.

As illustrated in FIG. 1, the outer package film 10 is a flexible outer package member that contains the battery device 20. The outer package film 10 has a pouch-shaped structure that is sealed in a state where the battery device 20 is contained inside the outer package film 10. The outer package film 10 thus contains an electrolytic solution together with a positive electrode 21 and a negative electrode 22 that are to be described later.

The outer package film 10 is not particularly limited in three-dimensional shape. Specifically, the outer package film 10 has a three-dimensional shape conforming to a three-dimensional shape of the battery device 20. Here, the outer package film 10 has an elongated, substantially cuboid three-dimensional shape conforming to an elongated three-dimensional shape of the battery device 20 to be described later.

The outer package film 10 is not particularly limited in configuration (e.g., material and the number of layers). The outer package film 10 may be a single-layered film or a multilayered film. The outer package film 10 is a single film and is foldable in a direction of an arrow F (of an alternate long and short dash line). The outer package film 10 has a depression part 10U to place the battery device 20 therein. The depression part 10U is what is called a deep drawn part.

Specifically, the outer package film 10 is a multilayered film including three layers: a fusion-bonding layer, a metal layer, and a surface protective layer that are stacked in this order from an inner side. That is, the outer package film 10 is a laminated film. In a state in which the outer package film 10 is folded, outer edge parts of the fusion-bonding layer opposed to each other are bonded to each other. The fusion-bonding layer includes a polymer compound such as polypropylene. The metal layer includes a metal material such as aluminum. The surface protective layer includes a polymer compound such as nylon.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry, for example, of outside air into the outer package film 10. The sealing film 41 includes a polymer compound such as a polyolefin that has adherence to the positive electrode lead 31. Specific examples of the polyolefin include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

As illustrated in FIGS. 1 and 2, the battery device 20 is contained inside the outer package film 10, and includes the positive electrode 21, the negative electrode 22, a separator 23, and the electrolytic solution.

The battery device 20 is what is called a wound electrode body. That is, in the battery device 20, the positive electrode 21 and the negative electrode 22 are stacked on each other with the separator 23 interposed therebetween, and the positive electrode 21, the negative electrode 22, and the separator 23 are wound about a winding axis P. The winding axis P is a virtual axis extending in a Y-axis direction. The positive electrode 21 and the negative electrode 22 are wound, being opposed to each other with the separator 23 interposed therebetween.

The battery device 20 has an elongated, substantially cylindrical three-dimensional shape. Accordingly, a section of the battery device 20 intersecting the winding axis P, that is, a section of the battery device 20 along an XZ plane, has an elongated shape defined by a major axis J1 and a minor axis J2, more specifically, an elongated, substantially elliptical shape. The major axis J1 is a virtual axis that extends in an X-axis direction and has a relatively large length. The minor axis J2 is a virtual axis that extends in a Z-axis direction intersecting the X-axis direction and has a relatively small length.

The positive electrode 21 includes, as illustrated in FIG. 3, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Examples of the metal material include aluminum.

Here, the positive electrode active material layer 21B is provided on each of the two opposed surfaces of the positive electrode current collector 21A. The positive electrode active material layer 21B includes any one or more of positive electrode active materials into which lithium is to be inserted and from which lithium is to be extracted. Note that the positive electrode active material layer 21B may be provided only on one of the two opposed surfaces of the positive electrode current collector 21A on a side where the positive electrode 21 is opposed to the negative electrode 22. In addition, the positive electrode active material layer 21B may further include, for example, a positive electrode binder and a positive electrode conductor. A method of forming the positive electrode active material layer 21B is not particularly limited, and is specifically a coating method, for example.

The positive electrode active material includes a lithium compound. The lithium compound is a compound that includes lithium as a constituent element, more specifically, a compound that includes lithium and one or more transition metal elements as constituent elements, for example. A reason for this is that a high energy density is obtainable. Note that the lithium compound may further include any one or more other elements other than lithium and the transition metal elements. The lithium compound is not particularly limited in kind, and is specifically an oxide, a phosphoric acid compound, a silicic acid compound, or a boric acid, for example. Specific examples of the oxide include LiNiO₂, LiCoO₂, and LiMn₂O₄. Specific examples of the phosphoric acid compound include LiFePO₄ and LiMnPO₄.

The positive electrode binder includes any one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes any one or more of electrically conductive materials including, without limitation, a carbon material. Examples of the carbon material include graphite, carbon black, acetylene black, and Ketjen black. Note that the electrically conductive material may be a metal material or a polymer compound, for example.

The negative electrode 22 includes, as illustrated in FIG. 3, a negative electrode current collector 22A and a negative electrode active material layer 22B.

The negative electrode current collector 22A has two opposed surfaces on each of which the negative electrode active material layer 22B is to be provided. The negative electrode current collector 22A includes an electrically conductive material such as a metal material. Examples of the metal material include copper.

Here, the negative electrode active material layer 22B is provided on each of the two opposed surfaces of the negative electrode current collector 22A, and includes the negative electrode active material described above. Note that the negative electrode active material layer 22B may be provided only on one of the two opposed surfaces of the negative electrode current collector 22A on a side where the negative electrode 22 is opposed to the positive electrode 21. In addition, the negative electrode active material layer 22B may further include, for example, a negative electrode binder and a negative electrode conductor. A method of forming the negative electrode active material layer 22B is not particularly limited, and specifically includes any one or more of methods including, without limitation, a coating method, a vapor-phase method, a liquid-phase method, a thermal spraying method, and a firing (sintering) method.

Details of the negative electrode binder are similar to those of the positive electrode binder, and details of the negative electrode conductor are similar to those of the positive electrode conductor.

Note that the negative electrode active material layer 22B may further include any one or more of other negative electrode active materials into which lithium is to be inserted and from which lithium is to be extracted. The one or more other negative electrode active materials include a carbon material, a metal-based material, or both, for example. A reason for this is that a high energy density is obtainable.

Examples of the carbon material include graphitizable carbon, non-graphitizable carbon, and graphite (natural graphite and artificial graphite). The metal-based material is a material that includes, as one or more constituent elements, any one or more elements among metal elements and metalloid elements that are each able to form an alloy with lithium. The metal elements and the metalloid elements are silicon, tin, or both. Note that the metal-based material may be a simple substance, an alloy, a compound, a mixture of two or more thereof, or a material including two or more phases thereof. Specific examples of the metal-based material include TiSi₂ and SiOₓ (0<x<1.5). Note that the negative electrode active material described above (see FIG. 1) is excluded from the metal-based material described here.

As illustrated in FIG. 3, the separator 23 is an insulating porous film interposed between the positive electrode 21 and the negative electrode 22, and allows a lithium ion to pass therethrough while preventing contact (a short circuit) between the positive electrode 21 and the negative electrode 22. The separator 23 includes a polymer compound such as polyethylene.

The positive electrode 21, the negative electrode 22, and the separator 23 are each impregnated with the electrolytic solution. The electrolytic solution includes a solvent and an electrolyte salt.

The solvent includes any one or more of non-aqueous solvents (organic solvents) including, without limitation, a carbonic-acid-ester-based compound, a carboxylic-acid-ester-based compound, and a lactone-based compound. The electrolytic solution including the non-aqueous solvent(s) is what is called a non-aqueous electrolytic solution. The electrolyte salt includes any one or more of light metal salts including, without limitation, a lithium salt.

As illustrated in FIG. 2, the positive electrode lead 31 is a positive electrode terminal coupled to the battery device 20 (the positive electrode 21). More specifically, the positive electrode lead 31 is coupled to the positive electrode current collector 21A. The positive electrode lead 31 is led to an outside of the outer package film 10. The positive electrode lead 31 includes an electrically conductive material such as aluminum. The positive electrode lead 31 is not particularly limited in shape, and specifically has any of shapes including, without limitation, a thin plate shape and a meshed shape.

As illustrated in FIG. 2, the negative electrode lead 32 is a negative electrode terminal coupled to the battery device 20 (the negative electrode 22). More specifically, the negative electrode lead 32 is coupled to the negative electrode current collector 22A. The negative electrode lead 32 is led to the outside of the outer package film 10. The negative electrode lead 32 includes an electrically conductive material such as copper. Here, the negative electrode lead 32 is led in a direction similar to that in which the positive electrode lead 31 is led. Note that details of a shape of the negative electrode lead 32 are similar to those of the shape of the positive electrode lead 31.

Upon charging the secondary battery, in the battery device 20, lithium is extracted from the positive electrode 21, and the extracted lithium is inserted into the negative electrode 22 via the electrolytic solution. Upon discharging the secondary battery, in the battery device 20, lithium is extracted from the negative electrode 22, and the extracted lithium is inserted into the positive electrode 21 via the electrolytic solution. Upon the charging and discharging, lithium is inserted and extracted in an ionic state.

The positive electrode 21 and the negative electrode 22 are each fabricated, and the electrolytic solution is prepared, following which the secondary battery is fabricated using the positive electrode 21, the negative electrode 22, and the electrolytic solution, according to a procedure to be described below.

First, the positive electrode active material, the positive electrode binder, and the positive electrode conductor are mixed with each other to thereby prepare a positive electrode mixture. Thereafter, the positive electrode mixture is put into the solvent to thereby prepare a positive electrode mixture slurry in paste form. The solvent is not particularly limited in kind, and may be specifically an aqueous solvent or a non-aqueous solvent (an organic solvent). The aqueous solvent is, for example, pure water, and details of the kind of the aqueous solvent described here are similarly applied to the following descriptions. Lastly, the positive electrode mixture slurry is applied on the two opposed surfaces of the positive electrode current collector 21A to thereby form the positive electrode active material layers 21B. Thereafter, the positive electrode active material layers 21B may be compression-molded by means of, for example, a roll pressing machine. In this case, the positive electrode active material layers 21B may be heated. The positive electrode active material layers 21B may be compression-molded multiple times. As a result, the positive electrode 21 is fabricated.

With use of the negative electrode active material described above, the negative electrode active material layer 22B is formed on each of the two opposed surfaces of the negative electrode current collector 22A by a procedure similar to the fabrication procedure of the positive electrode 21. Specifically, the negative electrode active material, the negative electrode binder, and the negative electrode conductor are mixed with each other to thereby prepare a negative electrode mixture. Thereafter, the negative electrode mixture is put into the solvent (the aqueous solvent) to thereby prepare a negative electrode mixture slurry in paste form. Thereafter, the negative electrode mixture slurry is applied on the two opposed surfaces of the negative electrode current collector 22A to thereby form the negative electrode active material layers 22B. Thereafter, the negative electrode active material layers 22B may be compression-molded. As a result, the negative electrode 22 is fabricated.

The electrolyte salt is put into the solvent. The electrolyte salt is thereby dispersed or dissolved in the solvent. As a result, the electrolytic solution is prepared.

First, the positive electrode lead 31 is coupled to the positive electrode 21 (the positive electrode current collector 21A) by a method such as a welding method, and the negative electrode lead 32 is coupled to the negative electrode 22 (the negative electrode current collector 22A) by a method such as a welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated). The wound body has a configuration similar to that of the battery device 20 except that the positive electrode 21, the negative electrode 22, and the separator 23 are each not impregnated with the electrolytic solution. Thereafter, the wound body is pressed by means of, for example, a pressing machine, to thereby shape the wound body into an elongated shape.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the outer package film 10 (the fusion-bonding layer) opposed to each other are bonded to each other by a method such as a thermal-fusion-bonding method to thereby allow the wound body to be contained inside the outer package film 10 having a pouch shape.

Lastly, the electrolytic solution is injected into the outer package film 10 having the pouch shape, following which outer edge parts of the remaining one side of the outer package film 10 (the fusion-bonding layer) are bonded to each other by a method such as a thermal-fusion-bonding method. In this case, the sealing film 41 is interposed between the outer package film 10 and the positive electrode lead 31, and the sealing film 42 is interposed between the outer package film 10 and the negative electrode lead 32. The wound body is thereby impregnated with the electrolytic solution. Thus, the battery device 20 that is a wound electrode body is fabricated, and the battery device 20 is sealed in the outer package film 10 having the pouch shape. As a result, the secondary battery is assembled.

The assembled secondary battery is charged and discharged. Conditions including, without limitation, an environment temperature, the number of times of charging and discharging (the number of cycles), and charging and discharging conditions may be set as desired. As a result, a film is formed on a surface of each of the negative electrode 22 and other components, which electrochemically stabilizes a state of the secondary battery. As a result, the secondary battery of the laminated-film type is completed.

According to the secondary battery of the present disclosure, the negative electrode 22 includes the negative electrode active material for a secondary battery described above. Accordingly, upon charging and discharging, lithium that is the battery reactant easily reaches the first object 1, and insertion and extraction of lithium are smoothly performed. This makes it possible to achieve superior battery performance.

The configuration of the secondary battery is appropriately modifiable including as described below according to an embodiment. Note that any two or more of the following series of modifications may be combined with each other.

The separator 23 that is a porous film is used. However, although not specifically illustrated here, a separator of a stacked type including a polymer compound layer may be used instead of the separator 23 that is the porous film.

For example, the separator of the stacked type includes a porous film having two opposed surfaces, and the polymer compound layer provided on one of or each of the two opposed surfaces of the porous film. A reason for this is that adherence of the separator to each of the positive electrode 21 and the negative electrode 22 improves to suppress the occurrence of misalignment (winding displacement) of the battery device 20. This helps to prevent the secondary battery from easily swelling even if, for example, a decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include any one or more kinds of insulating particles. A reason for this is that the insulating particles dissipate heat upon heat generation by the secondary battery, thus improving safety or heat resistance of the secondary battery. Examples of the insulating particles include inorganic particles and resin particles. Specific examples of the inorganic particles include particles of: aluminum oxide, aluminum nitride, boehmite, silicon oxide, titanium oxide, magnesium oxide, and zirconium oxide. Specific examples of the resin particles include particles of acrylic resin and particles of styrene resin.

In a case of fabricating the separator of the stacked type, a precursor solution including, without limitation, the polymer compound and an organic solvent is prepared, following which the precursor solution is applied on one of or each of the two opposed surfaces of the porous film. In this case, insulating particles may be added to the precursor solution on an as-needed basis.

When the separator of the stacked type is used also, a lithium ion is movable between the positive electrode 21 and the negative electrode 22, and similar effects are therefore obtainable.

The electrolytic solution, which is a liquid electrolyte, is used. However, although not specifically illustrated here, an electrolyte layer, which is a gel electrolyte, may be used instead of the electrolytic solution.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

For example, the electrolyte layer includes a polymer compound together with the electrolytic solution. The electrolytic solution is held by the polymer compound. A reason for this is that leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and the organic solvent is prepared, following which the precursor solution is applied on one side or both sides of the positive electrode 21 and one side or both sides of the negative electrode 22.

When the electrolyte layer is used also, a lithium ion is movable between the positive electrode 21 and the negative electrode 22 via the electrolyte layer, and similar effects are therefore obtainable.

Applications (application examples) of the secondary battery are not particularly limited. The secondary battery used as a power source may serve as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment including portable electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery packs may each include a single battery, or may each include an assembled battery. The electric vehicle is a vehicle that operates (travels) with the secondary battery as a driving power source, and may be a hybrid automobile that is additionally provided with a driving source other than the secondary battery as described above. In the electric power storage system for home use, electric power accumulated in the secondary battery that is an electric power storage source may be utilized for using, for example, home appliances.

An application example of the secondary battery will now be described in detail. The configuration of the application example described below is merely an example, and is appropriately modifiable.

FIG. 4 illustrates a block configuration of a battery pack. The battery pack described here is a battery pack (what is called a soft pack) including one secondary battery, and is to be mounted on, for example, electronic equipment typified by a smartphone.

As illustrated in FIG. 4, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a thermosensitive resistive device (a PTC device) 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited, and is specifically 4.2 V±0.05 V. The overdischarge detection voltage is not particularly limited, and is specifically 2.4 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement to be obtained by the temperature detector 59 is used, for example, when the controller 56 performs charge/discharge control upon abnormal heat generation or when the controller 56 performs a correction process upon calculating a remaining capacity.

### EXAMPLES

A description is given of Examples of the present technology according to an embodiment.

### Example 1 and Comparative Example 1

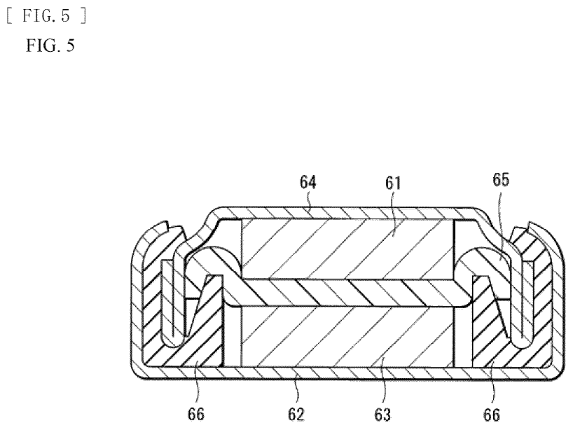

FIG. 5 illustrates a sectional configuration of a secondary battery of a coin type for testing. In the following, negative electrode active materials were manufactured, and secondary batteries of the coin type were fabricated using the negative electrode active materials. Thereafter, the secondary batteries were each evaluated for a battery characteristic.

The secondary battery of the coin type illustrated in FIG. 5 included a test electrode 61 placed inside an outer package cup 64, and included a counter electrode 63 placed inside an outer package can 62. The test electrode 61 and the counter electrode 63 were stacked on each other with a separator 65 interposed therebetween, and the outer package can 62 and the outer package cup 64 were crimped to each other by means of a gasket 66. The test electrode 61, the counter electrode 63, and the separator 65 were each impregnated with an electrolytic solution.

### [Manufacture of Negative Electrode Active Material]

In accordance with a procedure to be described below, the negative electrode active materials were manufactured.

### (Manufacture of Negative Electrode Active Material of Example 1)

First, SiO powder was prepared as the first object 1, and the SiO powder was put into a polygonal barrel provided inside a chamber of a barrel sputtering apparatus. SiO powder used here had an average particle size of 4 μm. Thereafter, a target of Cu as a raw material of the second object 2 was prepared, and was mounted inside the chamber of the barrel sputtering apparatus, following which a vacuum was drawn inside the chamber by a pump, and an Ar gas was introduced into the chamber. Thereafter, while the target was heated to a temperature of higher than or equal to 30° C. and lower than or equal to 100° C. by means of a heater, the polygonal barrel was rotated to repeat forward rotation and reverse rotation within a rotational angular range of ±60°, thereby causing the second object 2 to be selectively attached to the surface of the first object 1 inside the polygonal barrel. Thus, a negative electrode active material including the negative electrode active material particles 3 was obtained. Note that a Raman spectrum, an XRD spectrum, and a photoelectron spectrum of the obtained negative electrode active material of Example 1 were detected respectively by Raman spectroscopy, X-ray diffractometry, and X-ray photoelectron spectroscopy. As a result, it was confirmed that the Raman spectrum had a maximum peak within a range of greater than or equal to 470 cm⁻¹ and less than or equal to 490 cm⁻¹. Accordingly, it was confirmed that amorphous silicon included in the first object 1 was present on the surface layer of each of the negative electrode active material particles 3, that is, a portion of the surface of the first object 1 was exposed. Further, it was confirmed that the XRD spectrum had a peak within a range of 37±1 and a peak within a range of 44±1°. Accordingly, it was confirmed that Cu₂O and Cu were present on a surface of each of the negative electrode active material particles 3.

### (Negative Electrode Active Material of Comparative Example 1)

SiO powder having an average particle size of 4 μm was used as it was. A photoelectron spectrum of the negative electrode active material of Comparative example 1 was also detected by X-ray photoelectron spectroscopy. As a result, it was confirmed that an intensity of a peak within a range of greater than or equal to 930 eV and less than or equal to 938 eV in the photoelectron spectrum of the negative electrode active material of Example 1 was less than or equal to 25% of an intensity of a peak within a range of greater than or equal to 98 eV and less than or equal to 104 eV in the photoelectron spectrum of the negative electrode active material of Comparative example 1.

### [Fabrication of Secondary Battery of Example 1 and Comparative Example 1]

A lithium-ion secondary battery of the coin type illustrated in FIG. 5 was fabricated using each of the negative electrode active materials described above according to a procedure to be described below.

### (Fabrication of Test Electrode)

First, 80 parts by mass of the negative electrode active material, 5 parts by mass of the negative electrode binder (a styrene-butadiene-based rubber), 10 parts by mass of the negative electrode conductor (carbon black), and 5 parts by mass of a thickener (carboxymethyl cellulose) were mixed with each other to thereby prepare a negative electrode mixture. Thereafter, the negative electrode mixture was put into a solvent (pure water as an aqueous solvent), following which the negative electrode mixture was kneaded by means of a planetary centrifugal mixer to thereby prepare a negative electrode mixture slurry in paste form. Thereafter, the negative electrode mixture slurry was applied to one side of a negative electrode current collector (a copper foil having a thickness of 12 m) by means of a coating apparatus, following which the negative electrode mixture slurry was heated and dried (at a heating temperature of 120° C.). Thereafter, the negative electrode mixture slurry was subjected to vacuum drying to thereby form a negative electrode active material layer. Lastly, the negative electrode active material layer was compression-molded by means of a roll pressing machine. As a result, the test electrode 61 was fabricated.

### (Preparation of Counter Electrode)

Here, in order to fabricate a secondary battery for testing, a lithium metal plate was used as the counter electrode 63.

### (Preparation of Electrolytic Solution)

An electrolyte salt (lithium hexafluorophosphate) was added to a solvent (ethylene carbonate and ethyl methyl carbonate), following which the solvent was stirred. In this case, a mixture ratio (a mass ratio) between ethylene carbonate and ethyl methyl carbonate in the solvent was set to 50:50, and a content of the electrolyte salt was set to 1 mol/l (=1 mol/dm³) with respect to the solvent. As a result, the electrolytic solution was prepared.

### (Assembly of Secondary Battery)

First, the test electrode 61 was placed inside the outer package cup 64, and the counter electrode 63 was placed inside the outer package can 62. Thereafter, the test electrode 61 placed inside the outer package cup 64 and the counter electrode 63 placed inside the outer package can 62 were stacked on each other with the separator 65 (a microporous polyethylene film having a thickness of 25 m) impregnated with the electrolytic solution interposed therebetween. In this case, the gasket 66 (a fluororesin film having a thickness of 1.1 mm) was interposed between the outer package cup 64 and the outer package can 62. Lastly, the outer package cup 64 and the outer package can 62 were crimped to each other by means of the gasket 66.

Accordingly, the test electrode 61, the counter electrode 63, and the separator 65 were sealed in the outer package cup 64 and the outer package can 62. As a result, the secondary battery of the coin type was assembled.

### (Stabilization of Secondary Battery)

The secondary battery was charged and discharged for one cycle in an ambient temperature environment (at a temperature of 23° C.). Upon charging, the secondary battery was charged with a constant current of 0.2 C until a voltage reached 0.05 V, and was thereafter charged with a constant voltage of 0.05 V until a current reached 0.025 C. Upon discharging, the secondary battery was discharged with a constant current of 0.2 C until the voltage reached 1.5 V. Note that 0.2 C was a value of a current that caused a battery capacity (a theoretical capacity) to be completely discharged in 5 hours, and 0.025 C was a value of a current that caused the battery capacity to be completely discharged in 40 hours.

As a result, the secondary battery of the coin type was completed.

### [Evaluation of Battery Characteristic]

Evaluation of an initial charge capacity and an initial discharge capacity as the battery characteristic of each of the secondary batteries revealed the results presented in Table 1. Here, the secondary batteries were each first charged in an environment at 23° C. to thereby measure a charge capacity at that time, following which the secondary batteries were each discharged to thereby measure a discharge capacity. Note that charging descried here refers to an operation in a direction in which a lithium ion that is the battery reactant is inserted into a negative electrode.

TABLE 1

| | Initial | Initial | Coulombic |
|---|---|---|---|
| | charge | discharge | efficiency |
| | capacity [—] | capacity [—] | [—] |
| Example 1 | 0.97 | 1.23 | 1.27 |
| Comparative example 1 | 1 | 1 | 1 |

In Table 1, characteristic values of the initial charge capacity, the initial discharge capacity, and the initial coulombic efficiency of Example 1 are respectively represented as normalized values with respect to values of the initial charge capacity, the initial discharge capacity, and the initial coulombic efficiency of Comparative example 1 assumed to be 1. Note that the coulombic efficiency is a value of a ratio of the discharge capacity upon discharging with respect to the charge capacity charged upon charging expressed as a percentage, that is, discharge capacity/charge capacity.

As indicated in Table 1, it was confirmed that the coulombic efficiency of Example 1 improved, as compared with that of Comparative example 1. According to the secondary battery of the present disclosure, the second object 2 was attached to the surface of the first object 1 to be scattered. It was therefore confirmed that, upon charging and discharging, lithium as the battery reactant easily reached the first object 1 and insertion and extraction of lithium was smoothly performed.

Although the present disclosure has been described above with reference to one or more embodiments including Examples, the configuration of the present disclosure is not limited thereto, and is therefore modifiable in a variety of ways.

The description has been given of the case where the secondary battery has a battery structure of the laminated-film type; however, the battery structure is not particularly limited. Specifically, the battery structure may be, for example, of a cylindrical type, a prismatic type, a coin type, or a button type.

Further, the description has been given of the case where the battery device has a device structure of a wound type; however, the device structure of the battery device is not particularly limited. Specifically, the device structure may be, for example, of a stacked type in which the electrodes (the positive electrode and the negative electrode) are stacked on each other, or a zigzag folded type in which the electrodes are folded in a zigzag manner.

Further, the description has been given of the case where the electrode reactant is lithium; however, the electrode reactant is not particularly limited. Specifically, the electrode reactant may be another alkali metal such as sodium or potassium, or may be an alkaline earth metal such as beryllium, magnesium, or calcium, as described above. Alternatively, the electrode reactant may be another light metal such as aluminum.

Note that the applications of each of the negative electrode active material for a secondary battery and the negative electrode for a secondary battery are not limited to a secondary battery, and each of the negative electrode active material for a secondary battery and the negative electrode for a secondary battery may thus be applied to another electrochemical device such as a capacitor.

The effects described herein are mere examples, and effects of the present technology are therefore not limited to those described herein. Accordingly, the present technology may achieve other effects.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A negative electrode active material for a secondary battery, the negative electrode active material comprising:
a negative electrode active material particle including a first object including a silicon oxide, and
a second object including at least one of copper, a copper compound, tungsten,
or a molybdenum oxide and attached to a surface of the first object, wherein
a Raman spectrum of the negative electrode active material particle detected by Raman spectroscopy has a maximum peak within a range of greater than or equal to 470 wavenumbers and less than or equal to 490 wavenumbers,
an XRD spectrum of the negative electrode active material particle detected by X-ray diffractometry (XRD) has a peak within a range of within plus or minus 1 degree of 37 degrees and a peak within a range of within plus or minus 1 degree of 44 degrees, has a peak within a range of within plus or minus 1 degree of 40 degrees, or has a peak within any one of a range of within plus or minus 1 degree of 23 degrees, a range of within plus or minus 1 degree of 25 degrees, a range of within plus or minus 1 degree of 37 degrees, a range of within plus or minus 1 degree of 41 degrees, a range of within plus or minus 1 degree of 54 degrees, or a range of within plus or minus 1 degree of 60 degrees, and
an intensity of at least one of a peak within a range of greater than or equal to 227 electronvolts and less than or equal to 240 electronvolts or a peak within a range of greater than or equal to 930 electronvolts and less than or equal to 938 electronvolts in a photoelectron spectrum of the negative electrode active material particle detected by X-ray photoelectron spectroscopy (XPS) is less than or equal to 25 percent of an intensity of a peak within a range of greater than or equal to 98 electronvolts and less than or equal to 104 electronvolts in a photoelectron spectrum of the first object alone detected by X-ray photoelectron spectroscopy.

2. The negative electrode active material according to claim 1, wherein
the copper compound comprises at least one of CuO, Cu₂O, CuCO₃, or Cu(OH)₂, and
the molybdenum oxide comprises MoO₂, MoO₃, or both.

3. The negative electrode active material according to claim 1, wherein a composition ratio of Cu (copper) to Si (silicon) in the negative electrode active material particle determined from the photoelectron spectrum of the negative electrode active material particle detected by X-ray photoelectron spectroscopy is greater than or equal to 1 percent and less than or equal to 3 percent.

4. The negative electrode active material according to claim 1, wherein a coverage of the second object is greater than or equal to 1 percent and less than or equal to 3 percent of the first object in the negative electrode active material particle, the coverage being determined from the photoelectron spectrum of the negative electrode active material particle detected by X-ray photoelectron spectroscopy.

5. The negative electrode active material according to claim 1, wherein the second object is attached in a spot shape to selectively cover the surface of the first object.

6. The negative electrode active material according to claim 1, wherein a plurality of the second objects is scattered to selectively cover the surface of the first object.

7. A negative electrode for a secondary battery, the negative electrode comprising:
a negative electrode active material, wherein
the negative electrode active material includes a negative electrode active material particle, the negative electrode active material particle including
a first object including a silicon oxide, and
a second object including at least one of copper, a copper compound, tungsten, or a molybdenum oxide and attached to a surface of the first object,
a Raman spectrum of the negative electrode active material particle detected by Raman spectroscopy has a maximum peak within a range of greater than or equal to 470 wavenumbers and less than or equal to 490 wavenumbers,
an XRD spectrum of the negative electrode active material particle detected by X-ray diffractometry (XRD) has a peak within a range of within plus or minus 1 degree of 37 degrees and a peak within a range of within plus or minus 1 degree of 44 degrees, has a peak within a range of within plus or minus 1 degree of 40 degrees, or has a peak within any one of a range of within plus or minus 1 degree of 23 degrees, a range of within plus or minus 1 degree of 25 degrees, a range of within plus or minus 1 degree of 37 degrees, a range of within plus or minus 1 degree of 41 degrees, a range of within plus or minus 1 degree of 54 degrees, or a range of within plus or minus 1 degree of 60 degrees, and
an intensity of at least one of a peak within a range of greater than or equal to 227 electronvolts and less than or equal to 240 electronvolts or a peak within a range of greater than or equal to 930 electronvolts and less than or equal to 938 electronvolts in a photoelectron spectrum of the negative electrode active material particle detected by X-ray photoelectron spectroscopy (XPS) is less than or equal to 25 percent of an intensity of a peak within a range of greater than or equal to 98 electronvolts and less than or equal to 104 electronvolts in a photoelectron spectrum of the first object alone detected by X-ray photoelectron spectroscopy.

8. A secondary battery comprising:
a positive electrode;
a negative electrode including a negative electrode active material; and
an electrolytic solution, wherein
the negative electrode active material includes a negative electrode active material particle, the negative electrode active material particle including
a first object including a silicon oxide, and
a second object including at least one of copper, a copper compound, tungsten, or a molybdenum oxide and attached to a surface of the first object,
a Raman spectrum of the negative electrode active material particle detected by Raman spectroscopy has a maximum peak within a range of greater than or equal to 470 wavenumbers and less than or equal to 490 wavenumbers,
an XRD spectrum of the negative electrode active material particle detected by X-ray diffractometry (XRD) has a peak within a range of within plus or minus 1 degree of 37 degrees and a peak within a range of within plus or minus 1 degree of 44 degrees, has a peak within a range of within plus or minus 1 degree of 40 degrees, or has a peak within any one of a range of within plus or minus 1 degree of 23 degrees, a range of within plus or minus 1 degree of 25 degrees, a range of within plus or minus 1 degree of 37 degrees, a range of within plus or minus 1 degree of 41 degrees, a range of within plus or minus 1 degree of 54 degrees, or a range of within plus or minus 1 degree of 60 degrees, and
an intensity of at least one of a peak within a range of greater than or equal to 227 electronvolts and less than or equal to 240 electronvolts or a peak within a range of greater than or equal to 930 electronvolts and less than or equal to 938 electronvolts in a photoelectron spectrum of the negative electrode active material particle detected by X-ray photoelectron spectroscopy (XPS) is less than or equal to 25 percent of an intensity of a peak within a range of greater than or equal to 98 electronvolts and less than or equal to 104 electronvolts in a photoelectron spectrum of the first object alone detected by X-ray photoelectron spectroscopy.
